(19) United States
(12) Patent Application Publication
(10) Pub. No.: US 2009/0080467 A1
(43) Pub. Date: Mar. 26, 2009

(54) Pulse repetition frequency-multipler for fiber lasers

(76) Inventors: Andrei Starodoumov, Cupertino, CA (US); Sergei V. Govorkov, Los Altos, CA (US); Luis A. Spinelli, Sunnyvale, CA (US)

Correspondence Address: STALLMAN & POLLOCK LLP, 353 SACRAMENTO STREET, SUITE 2200, SAN FRANCISCO, CA, 94111, US

(21) Appl. No.: 11/903,638

(22) Filed: Sep. 24, 2007

(51) Int. Cl. H01S 3/067

(52) U.S. Cl. 372/6

(57) ABSTRACT

MOPA laser apparatus includes a master oscillator and a preamplifier providing a train of optical pulses. The pulse train is input to a fiber optic device arranged to multiply the pulse-repetition frequency (PRF) of the input pulse train. The PRF multiplying device divides each pulse in the into train into two pulses and delays one pulse relative to the other, some portion of one of the pulses and a portion of the other are delivered by the fiber optic PRF multiplying device as an output pulse-train having a PRF equal to twice the PRF of the input pulse train.

### TECHNICAL FIELD OF THE INVENTION

The present invention relates in general to pulsed master oscillator power-amplifier (MOPA) lasers. The invention relates in particular to methods of providing high-average power with low peak power in such lasers.

### DISCUSSION OF BACKGROUND ART

Modelocked pulsed (quasi CW) MOPA fiber lasers are preferred for laser material processing applications in microelectronics and other fields because they are very efficient, compact, and rugged compared, for example, to modelocked solid-state lasers. Many of the laser applications require the lowest possible peak power, or pulse energy, in order to minimize heat effects in materials being processed and damage to optics of a processing system. A high average power is preferred, however, for maximizing throughput. In order to achieve this, a high pulse-repetition frequency is required.

Maximum repetition rates of modelocked master oscillators in MOPA fiber-lasers are limited however to about 100 megahertz (MHz). This limitation is imposed by one or more factors, particularly, a minimum fiber-leads length required by fiber splicing procedure (about 5 centimeters per splice), and a minimum doped-fiber length required for pump absorption and gain in the cavity. The minimum fiber leads length is about 5 centimeters (cm) and the minimum doped-fiber length is about 10 cm. There is a need for a method of increasing the PRF of modelocked MOPA fiber-lasers beyond this limit, preferably to a PRF greater than about 200 MHz.

### SUMMARY OF THE INVENTION

The present invention is directed to apparatus for increasing the pulse-repetition frequency of a pulse train from a laser or MOPA laser. In one embodiment of apparatus in accordance with the present invention comprises a laser device arranged to deliver a first train of pulses at a first pulse-repetition frequency (PRF). A fiber optic PRF multiplier having an input port and an output port, is arranged to receive the train of pulses at the input port thereof, divide each pulse in the first train of pulses into first and second pulses, delay the first pulse relative to the second pulse and deliver a first portion of each of the second and delayed first pulses from the first output port thereof. This provides that a second train of pulses is delivered from the first output port of the PRF multiplier, the second train of pulses having a second PRF equal to twice the first PRF.

Preferably an arrangement is provided for detecting any differences between subsequent pulses in the second train of pulses. An amplitude adjusting arrangement is provided cooperative in a closed loop with the difference detecting arrangement for adjusting the amplitude of either the first or second pulses such that differences between the amplitude of pulses in the second train is minimized.

In another embodiment of an apparatus in accordance with the present invention the fiber optic PRF multiplier is arranged to receive the train of pulses at the input port thereof, divide each pulse in the first train of pulses into first and second pulses, deliver the second pulse from the output port thereof, amplify the first pulse and delay the amplified first pulse relative to the second pulse and deliver a first portion of the amplified delayed first pulse from the output port thereof. This also provides that a second train of pulses is delivered from the output port of the PRF multiplier, the second train of pulses having a second PRF equal to twice the first PRF.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates, in block diagram form a preferred embodiment of a MOPA fiber laser in accordance with the resent invention including a master oscillator, a fiber-preamplifier, a fiber amplifier, and a pulse-repetition frequency (PRF) multiplier located between the preamplifier and the amplifier.

FIG. 2 schematically illustrates a first preferred example of a PRF multiplier in accordance with the present invention, including a fiber Mach-Zehnder interferometer having first and second arms, with an amplitude control module located in the second arm.

FIG. 2A schematically illustrates one preferred example in accordance with the present invention of the amplitude control module of FIG. 2, including a periodically driven semiconductor optical amplifier.

FIG. 3 schematically illustrates a second preferred example of a PRF multiplier in accordance with the present invention, a fiber Michelson interferometer having first and second arms with an amplitude control module located in the second arm.

FIG. 4 schematically illustrates a third preferred example of a PRF multiplier in accordance with the present invention, including a three-port circulator having an input fiber attached to the first port, a multiplier fiber attached to the second port and an output fiber attached to the third port, with the multiplier fiber having a partially reflective fiber Bragg grating (FBG) therein and being terminated by a semiconductor amplifier.

FIG. 5 schematically illustrates a fourth preferred example of a PRF multiplier in accordance with the present invention, a fiber loop interferometer having an amplitude control module located in the fiber loop.

### DETAILED DESCRIPTION OF THE INVENTION

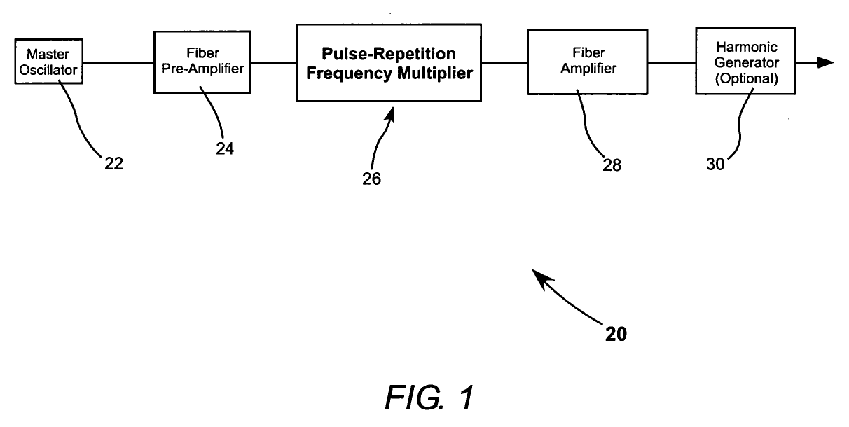

Referring now to the drawings, wherein like components are designated by like reference numerals, FIG. 1 schematically illustrates a preferred embodiment 20 of a MOPA fiber-laser in accordance with the present invention. Laser 20 includes a master oscillator (MO) 22, for example a modelocked fiber-laser. Such a MO can deliver pulse at a PRF up to about 100 MHz. MO 22 is connected to a fiber pre-amplifier 24, which performs a preliminary amplification of pulses from the MO at the delivered frequency. Pre-amplified pulses are then delivered to a pulse-repetition frequency multiplier (PRF multiplier) 26 in accordance with the present invention, preferred examples of which are described in detail further hereinbelow.

Two, temporally spaced apart pulses are delivered by the PRF-multiplier for every pre-amplified pulse delivered to the PRF-multiplier such that the output PRF of the PRF-multiplier is twice the PRF of the MO. Output pulses from PRF-multiplier 26 are amplified by a fiber power-amplifier 28 having one or more amplification stages.

The amplified pulses are pulses of radiation have a fundamental wavelength of the MO. Optionally, the amplified pulses can be delivered to a harmonic-generator including one or more optically nonlinear crystals (not shown) for converting the fundamental radiation pulses to pulses of radiation having a wavelength that is an integer sub-multiple of the fundamental wavelength

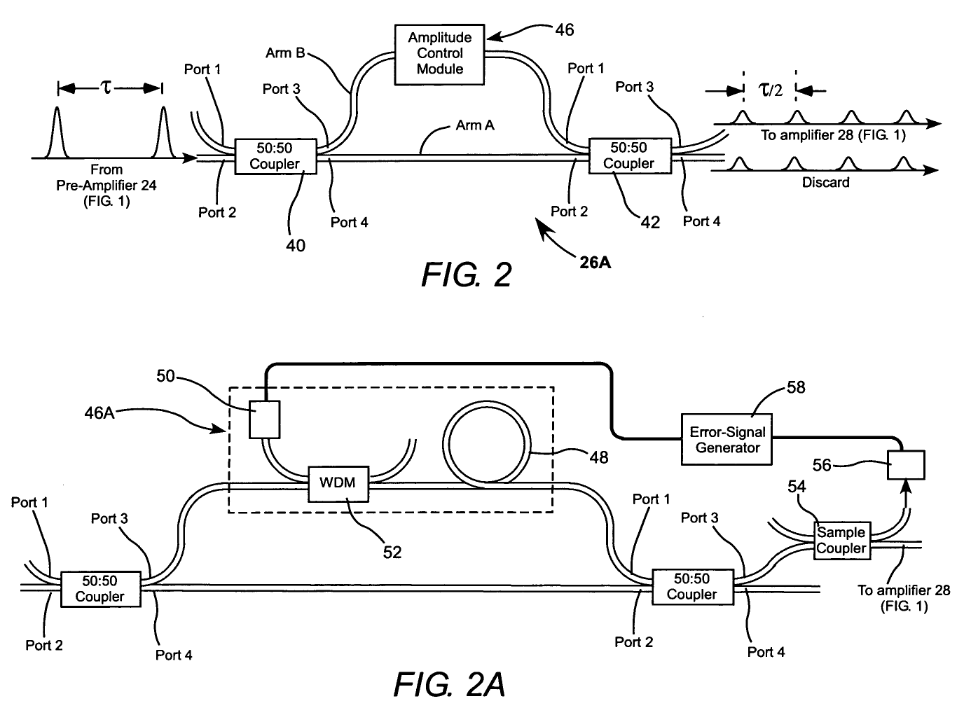

A description of several arrangements of PRF-multipliers in accordance with the present invention is set forth below with reference to FIGS. 2 through 5. The arrangements of FIGS. 2 through 4 are, in general, fiber devices including effectively two optically-connected arms. An input pulse is divided into two portions with each portion being sent into a separate one of the arms, portions of the pulse portions are then coupled back into a single output fiber to form a pulse train having a PRF twice that of the input-pulse PRF.

FIG. 2 schematically illustrates a first example 26A of such an arrangement, configured similar to a fiber Mach-Zehnder interferometer. In example 26A an input pulse is directed into a first port of a PM, four-port fiber-coupler 40. Radiation coupled into the slow- or fast-axes of the first port of such a coupler splits between two output ports (port-3 and port 4) with a coupling-ratio α. Optical power is split in proportion of α:1−α between the two output ports. Such a coupler may be referred to as a proportional or divisional coupler. Here, α is preferably 0.50, such that the input pulse is split in a 50:50 ratio. The output radiation is linearly polarized in both output ports. A simple modification of the four-port coupler, when one port is removed because no light is coupled into it, is called three-port PM coupler.

About 50% of the input pulse propagates along arm A of the PRF-multiplier and the remaining portion propagates along arm B of the PRF multiplier. Arm A has an optical path length different from that of arm B. Preferably an optical path length difference in the two arms is selected to be equal to L=T/2v_{g} (where v_{g} is the group velocity of light). In this case, radiation in each of the arms arrives at another 50:50 PM coupler 42 at different times to effectively form two separate pulses temporally spaced apart by one-half of the input pulse spacing. For a typical group velocity value of 205,000 km/s, a path difference of about 1.025 meters (m) is required to provide a delay of 5 ns.

Radiation arriving at port 1 of coupler 42 is divided about equally between port-3 and port 4 of coupler 42. Radiation arriving at port-2 of coupler 42 is similarly divided equally between port 3 and port 4 of the coupler. This provides that the output of each of ports 3 and 4 is a pulse train having a PRF that is twice the PRF of the MO with pulses in each of the trains having an amplitude about one-fourth that of the input pulses. The output of any one of ports 3 and 4 is directed to amplifier 28 (see FIG. 1) for further amplification, the other is discarded. This may seem, on first consideration, to be prohibitively wasteful of energy. Optical amplification in fibers, however, is a sufficiently efficient, high-gain process that half of the pre-amplified pulse energy can be discarded without a significant cost penalty.

PRF-multiplier 26A is depicted in FIG. 2 as including what is referred to as an “amplitude control module” 46. While not a required part of the inventive MOPA fiber-laser, amplitude control module 46 can be useful in cases, inter alia, where the couplers do not provide an exact 50:50 division between output ports. This can result in pulses in an output train from any one of the output ports have different peak power, which differences may be increased in any subsequent harmonic generation operations.

FIG. 2A schematically illustrates one example 46A of an amplitude control module 46, together with necessary control elements for the module. Amplitude control module 46A includes a length 48 of a doped-core optical gain fiber. The gain fiber is energized (optically pumped) by radiation from a semiconductor laser (diode-laser) 50 directed into the gain fiber via a wavelength division multiplex (WDM) coupler 52. A sampling coupler 54 having a relatively small coupling coefficient α, for example, about 0.01, directs a portion of the PRF-multiplied pulse-train being sent for further amplification (or further multiplication) to a fast photo-detector 56, the output of which is connected to an error signal generator 58. Error signal generator 58 provides an error signal proportional to the difference between consecutive pulses in the train. That error signal is used to adjust the output of the energizing diode-laser 50 in a closed-loop arrangement to adjust the gain of the amplifier fiber and drive the error signal to zero. The length of the gain fiber must be taken into account as being a part of the total length of arm B of the PRF-multiplier.

It should be noted here that the fiber amplifier arrangement in arm B is only one possible amplifier arrangement. Another optical amplifier such as a semiconductor optical amplifier (SOA) may be substituted without departing from the spirit and scope of the present invention. A variable attenuator may also be substituted for a variable gain amplifier. A semiconductor optical amplifier variably driven below threshold can function as a variable amplifier. Another example of a variable attenuator is a mechanical attenuator known as a gap-loss attenuator. In such an attenuator, the variable loss is induced by variably pulling fiber connector end-faces apart, i.e., varying a gap between the fiber end-faces. As radiation exits an end face in an expanding cone, the receiving end face will capture less radiation as the gap becomes larger. Such an attenuator is commercially available, for example, from Metrotek Inc. of St. Petersburg, Fla.

It should also be noted that once an optical amplifier or attenuator is placed in one arm of an interferometer a fiber-coupler split ratio of 50:50 used in passive interferometers (an interferometer without an amplitude control module) is no longer required. A coupler split-ratio can be arbitrarily determined by available gain or loss from an optical amplifier or attenuator. It is possible that if amplification of the PRF-multiplied pulse train is carried out with amplifier 28 operated in a saturated mode, the degree of saturation of the amplifier can be selected to even out variations in pulse power with an active amplitude control arrangement.

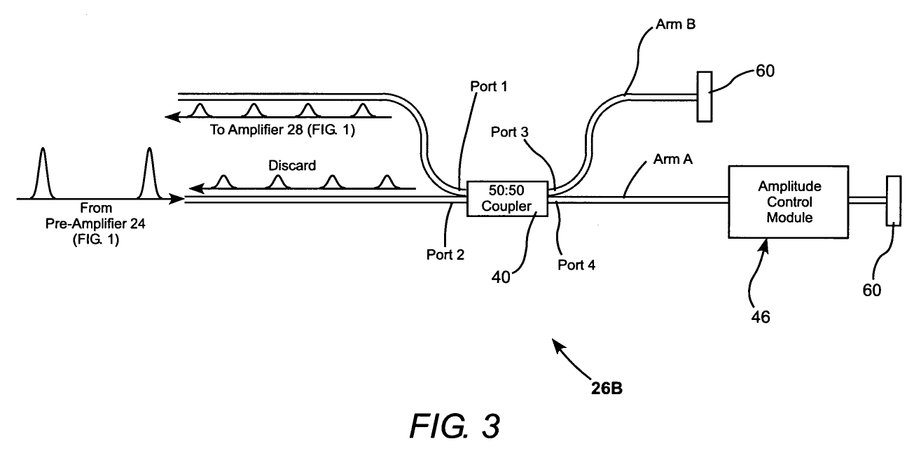

FIG. 3 schematically illustrates a second example 26B of a PRF-multiplier in accordance with the present invention based on a fiber Michelson interferometer. Here an input pulse is directed into port 2 of a 50:50 PM fused-coupler 40 and is divided about equally into arms A and B of the multiplier attached to ports 4 and 3, respectively of the coupler. One of the arms may include an amplitude control module 46 as described in detail above with reference to FIG. 2A. Here, module 46 is optionally included in arm A.

Each arm is terminated by a reflective device 60, which can be a fiber Bragg grating or a multilayer dielectric mirror. The mirrors reflect the pulse portions from the coupler back to the coupler where each pulse portion is split into two further portions that exit the coupler via ports 1 and 2 thereof. A result is that a pulse train is delivered from each of ports 1 and 2 of the coupler, with each pulse train having a PRF twice the PRF of the MO (the input pulse PRF) with pulses in the trains having a peak amplitude having an amplitude about one-fourth of the peak amplitude of an input pulse. The PRF-multiplied pulse train delivered from port 1 of coupler 40 is passed to amplifier 28 of FIG. 1 for further amplification. As the pulse train delivered from port 2 of the coupler is sent back along the optical fiber used to deliver the input pulse it is advisable to include an isolator between pre-amplifier 24 and the PRF multiplier to prevent the PRF-multiplied pulse-train from being fed back into the pre-amplifier.

It should be noted that in PRF multiplier 26B, the difference in fiber length required to provide a given optical path difference in arms A and B is only one-half that of the Mach-Zehnder based arrangement of PRF-multiplier 26A of FIG. 2. This is because the pulse portions in the two arms of PRF-multiplier 26B make a double-pass through the arms, which are in effect “folded” by reflectors 60.

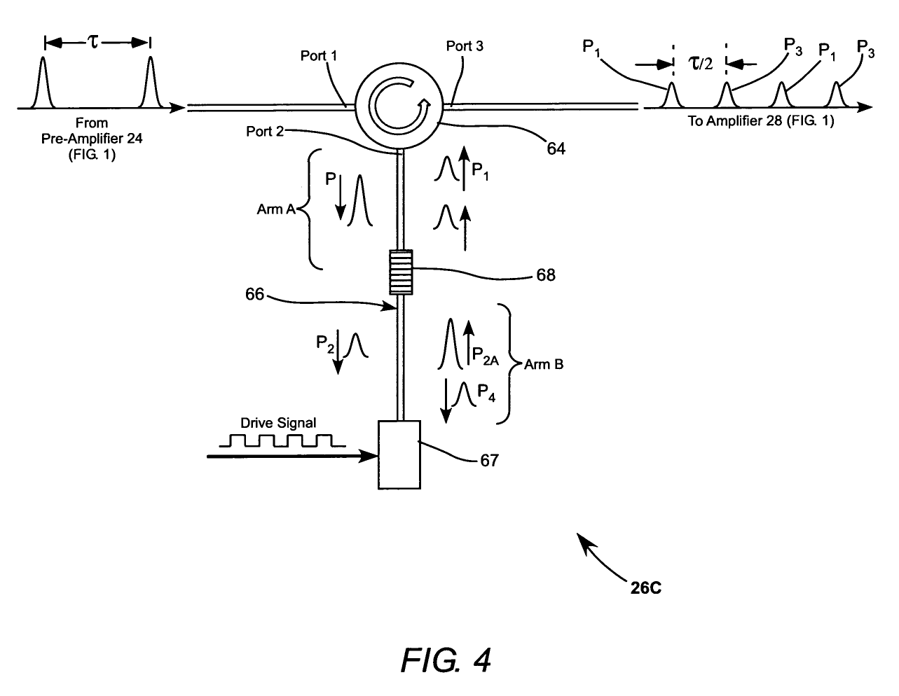

FIG. 4 schematically illustrates a third example 26C of a PRF-multiplier in accordance with the present invention. Here, an input pulse is directed into port 1 of a three-port circulator. A three port circulator is a fiber optic device having first second and third ports numbered consecutively and arranged such that radiation entering the first port is delivered from the second port and radiation entering the second port is delivered from the third port.

The input pulse entering port 1 of the circulator is directed by the circulator 64 into a length 66 of optical fiber terminated by a diode-laser 67, periodically operated in an amplification mode, and having a partially reflective, partially transmissive FBG 68 located between the circulator and the diode-laser. In accordance with the general description given above, the FBG 68 can be described as dividing fiber 66 into an arm A between FBG 68 and diodes 67 and an arm B between the FBG and the circulator. The FBG can be described as forming a type of fiber Fabry-Perot interferometer in arm B with the diode-laser, more specifically, with a highly reflective facet mirror of the diode-laser stripe.

Each input pulse (P) in a train thereof is partially reflected (pulse P₁) and partially transmitted (pulse P₂) by the FBG. Reflected pulses P₁ re-enter the circulator via port 2 and leaves through port 3 of circulator 64 at the input-pulse PRF. Arm B provides a resonator or a cavity for radiation partially transmitted through FBG 68. The length of arm B is preferably selected to provide a cavity round-trip length of one half of a pulse-period. Pulse P₂ is amplified (pulse P_{2A}) by passage into and out of the diode-laser cavity. A first portion of amplified pulse P_{2A} (pulse-portion P₃) will be transmitted by the FBG one-half of a pulse-period after pulse-portion P₁ is reflected by the FBG. Pulse Portion P₃ enters the circulator via port 2 thereof and leaves the circulator via port 3 thereof one-half of a pulse period after Pulse P₁. The output from port 3 of the circulator is a train of pulse-portions, alternating P₁ and P₃, and having a PRF twice the PRF of the input pulse.

A portion of pulse P_{2A} (pulse-portion P₄) is reflected by FBG 68 back toward the diode-laser. It is desirable to suppress this pulse portion to prevent the pulse portion from leaving arm B and interfering with a reflected pulse P₁ from a subsequent input pulse P. This is achieved by operating the diode-laser using a train (drive signal) of short current pulses such that the diode-laser amplifies (is “on” or active) during passage of pulse portion P2 and is “off” or inactive during the period when pulse-portion P4 arrives at the diode-laser. The diode-laser is active and inactive once during every pulse-period of the input pulse train. When the diode laser is “off” the diode-laser becomes an absorber, and effectively suppresses pulse-portion P₄. A result of this is that the output from port 3 of circulator 64 is a train of pulse-portions alternating P₁ and P₃ and having a PRF twice the PRF of the input pulse. Diode-laser 66 may be operated in a closed-loop mode with variable gain during on periods (as described above with reference to FIG. 2A) such that pulse portions in the output train thereof have equal amplitude.

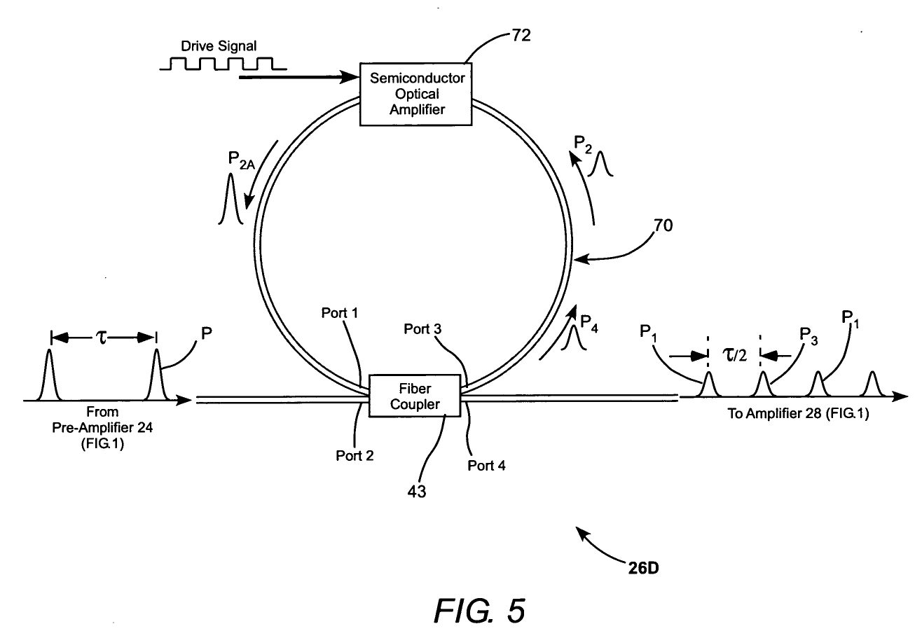

FIG. 5 schematically illustrates a third example 26D of a PRF-multiplier in accordance with the present invention. Here, each input pulse (P) in a train thereof is directed into port 2 of a fiber coupler 43. A portion (pulse) P₁ of the pulse exits the coupler via port 4 thereof, and another portion (pulse) P₂ is transmitted from port 3 of the circulator into a fiber loop 70 including a semiconductor optical amplifier (SOA) 72. Fiber loop 70 reconnects to the circulator via port 1 thereof. SOA 72 is periodically exited in the manner of diode-laser 66 of PRF-multiplier 26C. The length of loop 70 is selected to provide a round-trip time therein that is of one-half of a pulse-period of the input pulse-train.

Pulse P₂ is amplified (pulse P_{2A}) by passage through SOA 72. A first portion of amplified pulse P_{2A} (pulse-portion P₃) will be transmitted out of port 4 of circulator 43 one-half of a pulse-period after pulse-portion P₁ was transmitted. Part of this pulse-portion P_{2A} (pulse-portion P₄) is transmitted from port 3 of coupler 43 back into loop 70. Here again it is desirable to suppress this pulse portion to prevent the pulse-portion from leaving the loop and interfering with a pulse-portion P₁ of a subsequent input pulse P.

This suppression is achieved by periodically operating the SOA in the manner described above with reference to diode-laser (amplifier) 66 of PRF multiplier 26C. The output from port 4 of coupler 43 is a train of pulse-portions, alternating P₁ and P₃, and having a PRF twice the PRF of the input pulse. SOA 66 may be operated in a closed-loop mode with variable gain during “on” periods (as described above with reference to FIG. 2A) such that pulse-portions in the output train thereof have equal amplitude.

All of the above described PRF multipliers optimally multiply the PRF of an input pulse train by a factor of two. Those skilled in the art will recognize without further illustration or detailed description that if a greater multiplication factor is desired, the output of two or more of the inventive multipliers, not necessarily of the same type, may be cascaded together in series to increase the PRF input to the first by a factor of four, eight (using three cascaded multipliers), or more.

In summary the present invention is described above in terms of a preferred and other embodiments. The invention is not limited, however, to the embodiments described and depicted. Rather, the invention is limited only by the claims appended hereto.

1. Laser apparatus, comprising:
a laser device arranged to deliver a first train of pulses at a first pulse-repetition frequency (PRF);
a fiber optic PRF multiplier having an input port and a first output port, the PRF multiplier being arranged to receive the train of pulses at the input port thereof, divide each pulse in the first train of pulses into first and second pulses, delay the first pulse relative to the second pulse and deliver a first portion of each of the second and delayed first pulses from the first output port thereof; and
whereby a second train of pulses is delivered from the first output port of the PRF multiplier, the second train of pulses having a second PRF equal to twice the first PRF.

2. The apparatus of claim 1, wherein sequential pulses in the first train thereof are temporally separated by a pulse-period and the second pulse is delayed by one-half of the pulse-period, whereby sequential pulses in the second train of pulses are temporally separated by one-half of the first pulse period.

3. The apparatus of claim 1, wherein the fiber optic device includes a first fiber divisional coupler having an input port and first and second output ports, a second fiber divisional coupler having first and second input ports and first and second output ports, a first length of optical fiber connected between the first output port of the first coupler and the first input port of the second coupler and a second length of optical fiber connected between the second output port of the first coupler and the second input port of the second coupler, the first length of optical fiber being longer than the second length of optical fiber, the first port of the first coupler providing the input port of the PRF multiplier, the first output port of the second coupler providing the first output port of the PRF multiplier, and the second output port of the second coupler providing a second output port of the PRF multiplier.

4. The apparatus of claim 3, wherein the first coupler divides each input pulse into the first and second pulses and the first and second pulses propagate from the first coupler to the second coupler via respectively the first and second lengths of optical fiber, the difference in length between the first and second lengths of optical fiber providing the delay of the first pulse relative to the second pulse, and wherein the second coupler divides the each of the first and second pulses into first and second portions thereof, with the first and second pulse-portions being delivered from respectively the first and second output ports of the second coupler, whereby the second train of optical pulses is delivered from the first output port of the second coupler and a third train of pulses is delivered from the second output port of the PRF multiplier, the third train of pulses also having the second PRF.

5. The apparatus of claim 1, wherein the PRF multiplier includes a fiber divisional coupler having first, second, third and fourth ports, first and second lengths of optical fibers connected to respectively the third and fourth ports of the coupler with each thereof terminated by a reflective device, the first length of optical fiber being longer than the second length of optical fiber, the second port of the coupler providing the input port of the PRF multiplier and a second output port of the PRF multiplier, and the first port of the second coupler providing the first output port of the PRF multiplier.

6. The apparatus of claim 3, wherein the coupler divides each input pulse into the first and second pulses and the first and second pulses propagate from the coupler to the reflective devices via respectively the first and second lengths of optical fiber and are reflected by the reflective devices back into the coupler, the difference in length between the first and second optical fibers providing the delay of the first pulse relative to the second pulse, and wherein the coupler divides the each of the reflected first and second pulses into first and second portions thereof, with the first and second portions being delivered from respectively the first and second ports of the coupler, whereby the second-train of optical pulses is delivered from the first port of the coupler and a third train of pulses is delivered from the second port of the coupler.

7. Laser apparatus, comprising:
a laser device arranged to deliver a first train of pulses at a first pulse-repetition frequency (PRF);
a fiber optic PRF multiplier having an input port and an output port, the PRF multiplier being arranged to receive the train of pulses at the input port thereof, divide each pulse in the first train of pulses into first and second pulses, deliver the second pulse from the output port thereof, amplify the first pulse and delay the amplified first pulse relative to the second pulse and deliver a first portion of the amplified delayed first pulse from the output port thereof
whereby a second train of pulses is delivered from the output port of the PRF multiplier, the second train of pulses having a second PRY equal to twice the first PRF.

8. The apparatus claim 7, wherein sequential pulses in the first train thereof are temporally separated by a pulse-period and the second pulse is delayed by one-half of the pulse-period, whereby sequential pulses in the second train of pulses are temporally separated by one-half of the first pulse period.

9. The apparatus of claim 8, wherein the PRF-multiplier includes a three-port optical circulator having first, second, and third ports numbered in consecutive numerical order around the circulator, the first and third ports of the circulator providing the input and output ports of the PRF multiplier, and wherein there is a length of optical fiber connected at one end thereof to the second port of the circulator and at an opposite end thereof to a diode-laser with a partially reflective partially transmissive fiber Bragg grating (FBG) being formed in the optical fiber at a location spaced apart from the diode-laser, the diode-laser being periodically switchable between an active state and an inactive state once every pulse period of the input pulse train and functioning as an amplifier in the active state and an absorber in the inactive state.

10. The apparatus of claim 9, wherein each of the input pulses propagates from the first port of the circulator to the second port of the circulator, and from the second port of the circulator to the FBG, wherein the FBG divides the pulse into the first and second pulses with the second pulse being reflected from the FBG back into to second port of the circulator, propagating from the second port of the circulator to the third port of the circulator and being delivered from the third port of the circulator, wherein the first pulse is transmitted by the FBG, is amplified by the diode-laser switched to an active state and reflected back into the optical fiber by the diode-laser and propagates back to the FBG, wherein a first portion of the amplified first pulse is transmitted by the FBG enters the circulator via the second port thereof and is delivered by the circulator from the third port thereof with the separation of the FBG and the diode-laser being selected to provide a delay of one-half of a pulse period of the input pulse train between delivery of the second pulse and the first portion of the delayed amplified first pulse.

11. The apparatus of claim 10, wherein the second portion of the delayed amplified first pulse is reflected back to the diode-laser with the diode-laser switched to an inactive state and is absorbed in the diode-laser.

12. The apparatus of claim 8, wherein the PRF-multiplier includes a fiber divisional coupler having first and second input ports and first and second output ports the second input port of the coupler and the second output port of the coupler providing the input and output ports of the PRF multiplier, and wherein there is a length of optical fiber connected at one end thereof to the first output port of the coupler and at an opposite end, thereof to the first input port of the coupler with an optical amplifier being included in the length of optical fiber, the amplifier being periodically switchable between an active state and an inactive state once every pulse period of the input pulse train and functioning as an amplifier in the active state and as an absorber in the inactive state.

13. The apparatus of claim 12, wherein each of the input pulses is received at the second input port of the coupler and the coupler divides each input pulse into the first and second pulses with the second pulse being delivered from the coupler via the second output port thereof and the first pulse being delivered from the first output port of the coupler into the length of optical fiber, amplified by the optical amplifier switched to an active state and delayed by passage through the optical fiber and transmitted back into the coupler via the first input port thereof, the coupler dividing the delayed amplified pulse into the first portion thereof that is delivered from the second output port of the coupler and a second portion thereof that is delivered form the first output port of the coupler back into the optical fiber, with the length of the optical fiber being selected to provide a delay of one-half of a pulse period of the input pulse train between delivery of the second pulse and the first portion of the delayed amplified first pulse.

14. The apparatus of claim 13, wherein the second portion of the delayed amplified first pulse enters the optical amplifier with the amplifier switched to an inactive state and is absorbed in the optical amplifier.

15. Laser apparatus, comprising:
a laser device arranged to deliver a first train of pulses at a first pulse-repetition frequency (PRF);
a fiber optic PRF multiplier having an input port and an output port, the PRF multiplier being arranged to receive the train of pulses at the input port thereof, divide each pulse in the first train of pulses into first and second pulses, delay the first pulse relative to the second pulse and deliver a first portion of each of the second and delayed first pulses from the first output port thereof such that a second train of pulses is delivered from the first output port of the PRF multiplier, the second train of pulses having a second PRF equal to twice the first PRF;
a detector for monitoring any differences between the amplitude of first portions of the first pulse and first portions of the second pulse in the second train of pulses; and
an arrangement responsive to the detector arrangement for adjusting the amplitude of one of the first pulses and the second pulses to minimize differences between the pulse-portions in the second train of pulse.

16. The apparatus of claim 1, wherein the amplitude-adjusting arrangement includes an optical amplifier having variable gain arranged to adjust the amplitude of the first pulses.
